(19) United States
(12) Patent Application Publication
(10) Pub. No.: US 2026/0172289 A1
(43) Pub. Date: Jun. 18, 2026

(54) SHRINK: Dynamic Data-Driven Channel Sounding for Reduced MIMO Feedback Overhead in Wi-Fi

(71) Applicants: Northeastern University, Boston, MA (US); University of Brescia, Brescia (IT)

(72) Inventors: Francesco Restuccia, Boston, MA (US); Francesca Meneghello, Boston, MA (US); K M Rumman, Boston, MA (US); Khandaker Foysal Haque, Somerville, MA (US); Francesco Gringoli, Brescia (IT)

(21) Appl. No.: 19/425,782

(22) Filed: Dec. 18, 2025

Related U.S. Application Data
(60) Provisional application No. 63/735,833, filed on Dec. 18, 2024.

(51) Int. Cl. H04L 25/02; H04B 7/0413; H04L 5/00

(52) U.S. Cl. CPC H04L 25/022; H04B 7/0413; H04L 5/0055; H04L 25/0224

(57) ABSTRACT

A method of channel-sounding in a wireless communication system comprises transmitting, by an access point transceiver, a solicitation for channel frequency response (CFR) feedback, and determining, by a station transceiver, a current channel frequency response for each multiple-input multiple-output (MIMO) channel between the access point transceiver and the station transceiver. The method may further comprise determining, by the station transceiver using a throughput variation predictor, a predicted prior throughput variation resulting from precoding use of a prior channel frequency response produced from a channel sounding interval immediately preceding a current channel sounding interval. The method may further comprise transmitting, by the station transceiver, the current channel frequency response when the throughput variation exceeds a throughput variation threshold, and transmitting, by the station transceiver, a not-acknowledge (NACK) message when the throughput variation does not exceed the throughput variation threshold. The wireless communication system may be an IEEE 802.11 communication system.

### RELATED APPLICATION

This application claims the benefit of U.S. Provisional Application No. 63/735,833, filed on Dec. 18, 2024. The entire teachings of the above application are incorporated herein by reference.

### GOVERNMENT SUPPORT

This invention was made with government support under Grant No. FA9550-23-1-0261 awarded by the U.S. Air Force Office of Scientific Research, Grant No. CNS-2134973 awarded by the National Science Foundation, and Grant no. N00014-23-1-2221 awarded by the U.S. Office of Naval Research. The government has certain rights in the invention.

### BACKGROUND

Today, Wi-Fi is the most widespread wireless technology in the world, and it is expected to increase by more than 4 billion devices each year. This growing connectivity demand calls for efficient use of the radio spectrum. As such, multiple-input, multiple-output (MIMO) communication has been proposed to improve spectrum efficiency. MIMO facilitates simultaneous transmission of information to multiple users in the same frequency band by using multiple antennas, thus significantly improving spectrum efficiency. While the theoretical capacity of MIMO systems increases with the number of antennas, in practice it is limited by the overhead imposed by the channel sounding procedure, which is essential to enable MIMO transmissions and does not scale well with the number of antennas. Indeed, by using the currently adopted procedure in the IEEE 802.11ax/be standards with M antennas and bandwidth B, the feedback size increases as M². B. For example, a 16×16 Wi-Fi MIMO network operating with 160 MHz of bandwidth would require transmitting about 77 KB per feedback instance, which is 20 times the size of a 4×4 feedback. This leads to an overhead of 61.5 Mbps for a typical sounding interval of 10 ms. This bottleneck ultimately prevents fully reaching the throughput gains theoretically attainable by MIMO.

To reduce overhead, several feedback compression strategies have been proposed. With these strategies, however, compression is applied in the same way regardless of the actual changes in the wireless propagation environment, which is a sub-optimal approach. Indeed, overhead can be further reduced by adapting the sounding rate to the changes in the radio channel. For example, Bejarano et al. proposed MUTE [Oscar Bejarano, Eugenio Magistretti, Omer Gurewitz, and Edward W. Knightly, “MUTE: Sounding Inhibition for MU-MIMO WLANS,” In Proceedings of IEEE International Conference on Sensing, Communication, and Networking (SECON), pages 135-143. IEEE, 2014] uses prior channel state information (CSI) estimates to predict the variation in the propagation channel. MUTE, along with other strategies, adjusts the sounding interval based on the station (STA) throughput estimated by the access point (AP).

### SUMMARY

The embodiments described herein are directed to methods of and systems for an efficient channel sounding procedure that determines an accurate estimate of channel state information (CSI). In prior systems, the determination of CSI is executed at the access point (AP), where the prediction about the channel variation or the throughput degradation relies on the historical channel and throughput estimates. In the described embodiments, the CSI determination occurs at the station (STA), thereby evaluating the current channel conditions rather than using the historical data. This key feature allows the described embodiments to outperform existing approaches.

FIG. 1 shows channel sounding according to the described embodiments. Based on the data-driven throughput variation prediction, the STA 102 feeds back to the AP 104 the compressed channel information 106 (i.e., the IEEE 802.11 feedback) or a shorter NACK 108. The described embodiments predict the throughput variation that would occur when not feeding back the new channel estimate to the AP 102. Based on this, the STA 104 decides whether to feed back the standard IEEE 802.11 feedback or a not-acknowledgement (NACK) frame 108 to inform the AP 102 that the channel can be considered static, and a channel estimate update is not needed, thereby substantially reducing the overhead due to channel estimation and ultimately increasing network throughput.

The described embodiments provide a new channel sounding procedure where the STAs decide whether to update the channel estimate available at the AP based on local prediction (local to the STA) of the throughput variation. While prior approaches select the STAs to be sounded at the AP, the described embodiments evaluate CSI at the STAs. As such, the decision to provide 802.11 feedback or not relies on the most recent channel and throughput measurements evaluated at the STA, thus drastically improving the performance. The described embodiments can be applied both in single-user multi-input, multi-output (SU-MIMO) and multi-user MIMO (MU-MIMO) networks.

The described embodiments utilize a data-driven procedure to predict the throughput variation that would occur by using the prior channel estimate at the AP for precoding. The procedure is performed by every STA and is trained to automatically link the variations in the channel estimate with the changes in the throughput experienced at the STA. This information is used by each STA to decide whether to transmit the new estimate.

The described embodiments were evaluated through experimental evaluation performed on commercial-off-the-shelf (COTS) Wi-Fi devices. An extensive data collection campaign was performed in three different environments, including an anechoic chamber. Evidence is presented herein that reducing the channel sounding is possible on COTS devices and is effective in increasing the network throughput. An example embodiment was compared against existing baselines, Dynamic sounding, and Motion-aware MIMO. Experimental results show that the example embodiment reduces airtime and data overhead by 0.3 ms and 0.23 KB on average with respect to the existing approaches, which corresponds to an average throughput gain of 24.5%.

In one aspect, the invention may be a method of channel-sounding in a wireless communication system, comprising transmitting, by an access point transceiver, a solicitation for channel frequency response (CFR) feedback, and determining, by a station transceiver, a current channel frequency response for each multiple-input multiple-output (MIMO) channel between the access point transceiver and the station transceiver. The method may further comprise determining, by the station transceiver using a throughput variation predictor, a predicted prior throughput variation resulting from precoding use of a prior channel frequency response produced from a channel sounding interval immediately preceding a current channel sounding interval, transmitting, by the station transceiver, the current channel frequency response when the throughput variation exceeds a throughput variation threshold, and transmitting, by the station transceiver, a not-acknowledge (NACK) message when the throughput variation does not exceed the throughput variation threshold.

The wireless communication system may be an IEEE 802.11 communication system. Predicting the prior throughput variation further may comprise determining accuracy of a throughput variation predictor, and transmitting, by the station receiver, the current channel frequency response when the accuracy of the throughput variation predictor does not meet an accuracy requirement. Determining accuracy of the throughput variation predictor may further comprise (i) determining an actual prior throughput variation that occurred for the channel sounding interval immediately preceding the current channel sounding interval, (ii) determining that the accuracy of the throughput variation predictor meets the accuracy requirement when a magnitude of a difference between the actual prior throughput variation and the predicted prior throughput variation is less than or equal to an accuracy threshold, and (iii) determining that the accuracy of the throughput variation predictor does not meet the accuracy requirement when the magnitude of the difference between the actual prior throughput variation and the predicted prior throughput variation is greater than the accuracy threshold.

Predicting the throughput variation may further comprise (i) determining, from the current channel frequency response, a current beamforming matrix Vᵢ₍ₜ₎, (ii) determining, from the prior channel frequency response, a prior beamforming matrix Vᵢ₍ₜ₋₁₎, and (iii) predicting, by a learning-based model, the throughput variation based on Vᵢ₍ₜ₎ and Vᵢ₍ₜ₋₁₎ as inputs to the learning-based model. The learning-based model may use a Visual Geometry Group (VGG)-based convolutional neural network (CNN) architecture. The method may further comprise training the learning-based model by (a) providing a training database of current training channel frequency response and prior training channel frequency response pairs, and (b) forwarding the current channel frequency response and prior channel frequency response pairs to the learning-based model. The method may further comprise using a mean squared error loss function to quantify an error between the current training channel frequency response and prior training channel frequency response pairs and using a gradient-based optimization to adjust parameters of the learning-based model. The method may further comprise employing an elastic weight consolidation technique to refine the learning-based model, wherein parameters of the learning-based model may be updated by backpropagating a gradient of a Fisher information matrix-based loss function.

In another aspect, the invention may be a wireless communication system for channel-sounding, comprising an access point transceiver that transmits a solicitation for channel frequency response (CFR) feedback, a station transceiver that, in response to the solicitation, (i) determines a current channel frequency response for each multiple-input multiple-output (MIMO) channel between the access point transceiver and the station transceiver, (ii) determines, using a throughput variation predictor, a predicted prior throughput variation resulting from precoding use of a prior channel frequency response produced from a channel sounding interval immediately preceding a current channel sounding interval, (iii) transmits the current channel frequency response when the throughput variation exceeds a threshold, and (iv) transmits a not-acknowledge (NACK) message when the throughput variation does not exceed the threshold.

The wireless communication system may be an IEEE 802.11 communication system. The station transceiver may further determine accuracy of a throughput variation predictor, and transmits the current channel frequency response when the accuracy of the throughput variation predictor does not meet an accuracy requirement. To determine accuracy of the throughput variation predictor, the station transceiver may further (i) determine an actual prior throughput variation that occurred for the channel sounding interval immediately preceding the current channel sounding interval, (ii) determine that the accuracy of the throughput variation predictor meets the accuracy requirement when a magnitude of a difference between the actual prior throughput variation and the predicted prior throughput variation is less than or equal to an accuracy threshold, and (iii) determine that the accuracy of the throughput variation predictor does not meet the accuracy requirement when the magnitude of the difference between the actual prior throughput variation and the predicted prior throughput variation is greater than the accuracy threshold.

To predict the throughput variation, the station transceiver may further (i) determine, from the current channel frequency response, a current beamforming matrix Vᵢ₍ₜ₎, (ii) determine, from the prior channel frequency response, a prior beamforming matrix Vᵢ₍ₜ₋₁₎; and (iii) predict, by a learning-based model, the throughput variation based on Vᵢ₍ₜ₎ and Vᵢ₍ₜ₋₁₎ as inputs to the learning-based model. The learning-based model may use a Visual Geometry Group (VGG)-based convolutional neural network (CNN) architecture. To train the learning-based model, the station transceiver may further (a) provide a training database of current training channel frequency response and prior training channel frequency response pairs, and (b) forward the current channel frequency response and prior channel frequency response pairs to the learning-based model.

The station transceiver may use a mean squared error loss function to quantify an error between the current training channel frequency response and prior training channel frequency response pairs and use a gradient-based optimization to adjust parameters of the learning-based model. The station transceiver may further employ an elastic weight consolidation technique to refine the learning-based model, and wherein parameters of the learning-based model may be updated by backpropagation of a gradient of a Fisher information matrix-based loss function.

In another aspect, the invention may be a method of channel-sounding, comprising determining, by a station transceiver in response to a solicitation for channel frequency response (CFR) feedback, a current channel frequency response for channels between a source of the solicitation and the station transceiver, and determining, by the station transceiver, a predicted prior throughput variation resulting from precoding use of a prior channel frequency response produced from a channel sounding interval immediately preceding a current channel sounding interval. The method may further comprise transmitting, by the station transceiver, the current channel frequency response when the throughput variation exceeds a throughput variation threshold, and transmitting, by the station transceiver, a not-acknowledge (NACK) message when the throughput variation does not exceed the throughput variation threshold.

Predicting the prior throughput variation may further comprise determining accuracy of a throughput variation predictor, and transmitting, by the station receiver, the current channel frequency response when the accuracy of the throughput variation predictor does not meet an accuracy requirement.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 shows channel sounding according to the described embodiments.

FIG. 2 shows interactions between the AP and the STAs in a IEEE 802.11 system.

FIG. 3 shows an analytical analysis of the amount of feedback data and airtime overhead in IEEE 802.11 networks.

FIG. 4 shows an example embodiment of the invention.

FIG. 5 summarizes the sounding procedure of the described embodiments.

FIGS. 6A and 6B show the feedback matrices obtained at a STA together with the throughput variation.

FIG. 7 summarizes the feedback type decision block processing of the example embodiment.

FIG. 8 shows an experimental setup for evaluating the example embodiment.

FIGS. 9A, 9B, and 9C show performance of the CNN-based throughput variation predictor over time of the example embodiment.

FIGS. 10A, 10B, and 10C provide some visual examples of actual versus SHRINK CNN-based predicted throughput variations in all environments.

FIG. 11 shows the performance of the proposed CL approach when changing the number of samples used to retrain the network at runtime.

FIG. 12A shows the MSE of a model, pre-trained in the anechoic chamber, in the laboratory space and the study room.

FIG. 12B shows the MSE of a model, pre-trained in the laboratory space, in the study room and the anechoic chamber.

FIG. 12C shows the MSE of a model, pre-trained in the study room, in the laboratory space and the anechoic chamber.

FIG. 13 shows the feedback type selected by the two STAs in the network when they both use the SHRINK mechanism.

FIG. 14 shows the data overhead of the two STAs in the different environments for SHRINK and IEEE 802.11.

FIG. 15 shows the airtime overhead of the two STAs in the different environments for SHRINK and IEEE 802.11.

FIG. 16 shows the throughput gain and average throughput of the two STAs in the in different environments for SHRINK with respect to IEEE 802.11.

FIGS. 17A, 17B, and 17C show that SHRINK outperforms these approaches in terms of data and airtime overhead, and overall throughput gain at the STA.

FIG. 18 shows that in stable channels (no movement), SHRINK transmits NACK, reducing control data overhead.

FIG. 19 shows an example of the throughput variation estimated by Dynamic Sounding and Motion-aware MIMO in the laboratory space.

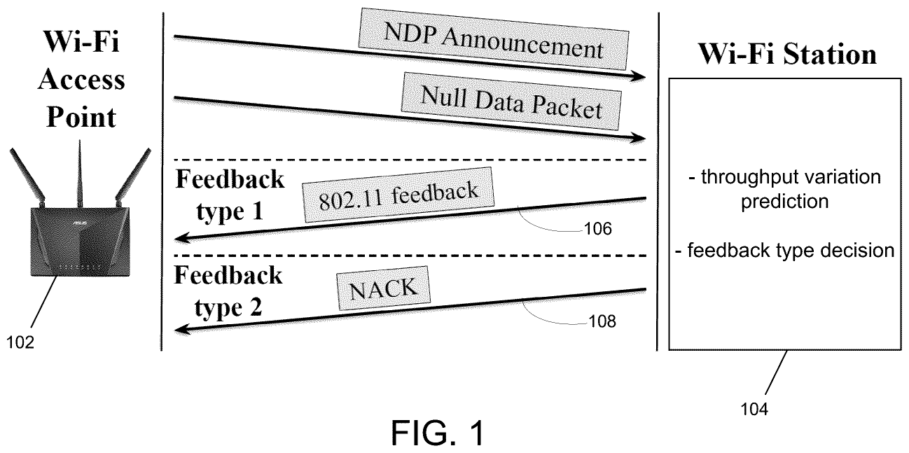

### DETAILED DESCRIPTION

A description of example embodiments follows.

The embodiments described herein are directed to methods of and systems for an efficient channel sounding procedure that determines an accurate estimate of channel state information (CSI). The described embodiments may be referred to herein as SHRINK, the SHRINK method, or the SHRINK system.

Consider an IEEE 802.11 wireless network consisting of a set of stations (STAs), each identified by an index i∈{1, . . . , S}, such that STAᵢ is equipped with Nᵢ antennas. The STAs are served with N_{ss,i} data streams each by a M-antenna access point (AP). K is used to indicate the number of orthogonal frequency-division multiplexing (OFDM) subcarriers used. Note that K varies with the bandwidth and the sub-channel spacing Δf.

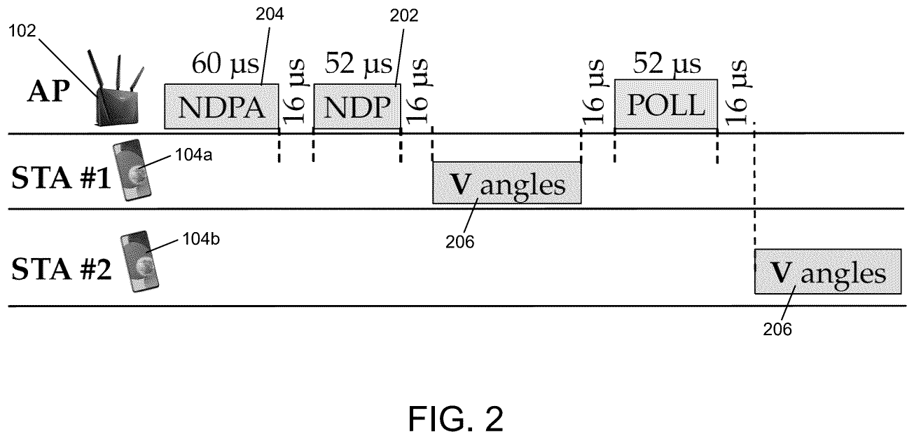

IEEE 802.11 Channel Sounding. In MIMO transmissions, data streams are linearly combined using a precoding matrix W derived from the channel frequency response (CFR) Hᵢ. Channel State Information (CSI) refers to the known channel properties of a communication link, while the Channel Frequency Response (CFR) is a specific, fine-grained measurement used to represent that information in the frequency domain. Essentially, CFR is the data (amplitude and phase information per subcarrier) that is a component of the overall CSI measurement. The AP acquires each Hᵢ through channel sounding. The interactions between the AP and the STAs are summarized in FIG. 2. These operations are explained below.

The 802.11 AP periodically broadcasts null data packet (NDP) frames previously announced by null data packet announcement (NDPA) transmissions. The NDP contains training fields used to estimate the MIMO channel between the STAs and the AP. Using this NDP, each STAs estimates the CFR between each pair of transmitter and receiver antennas. This creates a K×M×Nᵢ matrix Hᵢ for the i^{th} STA. Next, the STA selects the number of OFDM subchannels with which to feed back the information to the AP. This is done to reduce the dimension of the feedback and, in turn, the latency introduced by control data transmission. \tilde{K} is used to indicate the number of sub-channels for which the feedback is reported. This strategy is referred to as sub-channel grouping and the sampling factor is included by the STA in the feedback using the grouping sub-field in the feedback frame. Hence, the \tilde{K}×M×Nᵢ CFR is compressed through singular value decomposition (SVD). Only the first N_{ss,i} columns of the right singular matrix are retained as they suffice to obtain proper precoding. This \tilde{K}×M×N_{ss,i} matrix is the beamforming feedback matrix and is indicated by Vᵢ. Next, Givens rotations are used to obtain the beamforming feedback angles (referred to as V angles in the following), from which the Vᵢ is fully reconstructed. The angles are identified by symbols φ and ψ and are then quantized. Their number and the number of bits per angle are specified in the IEEE 802.11 standard. Finally, the quantized angles are transmitted to the AP, which reconstructs Vᵢ to be used for precoding the multiple data streams.

IEEE 802.11 Airtime and Data Overhead. The IEEE 802.11 channel sounding procedure requires each i^{th} STA to transmit

$$[ {\sum }_{ℓ = 1}^{min ( {N}_{ss , i} , M - 1 )} ( M - ℓ ) ] \cdot ( {b}_{ϕ} + {b}_{ψ} ) \cdot \tilde{K} bits ,$$

where b_{φ} and b_{ψ} are the number of bits used to quantize the φ and ψ angles, respectively. However, it is known that quantization leads to higher bit error rate (BER). In addition, the amount of channel feedback data remains substantial.

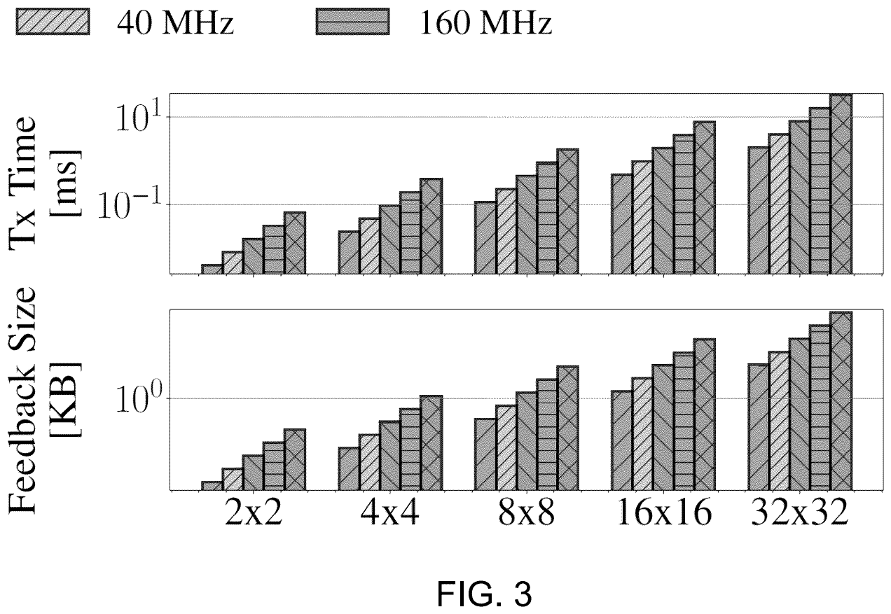

To clarify this issue, FIG. 3 presents an analytical analysis of the amount of feedback data and airtime overhead in IEEE 802.11 networks when varying the MIMO configurations and the operational bandwidth. We used b_{φ}=4 and b_{ψ}=2 as the number of quantization bits, which is the lowest number of bits that can be used for SU-MIMO feedback and N_{g}=16 as the sub-channel grouping factor. For example, with 32 transmitting antennas, 320 MHz bandwidth and 32 data streams, the feedback size is 95.23 KB which corresponds to an airtime overhead of about 31.7 ms, which is more than the suggested value of 10 ms as per relevant literature. In addition, excessive feedback size reduces the network throughput. As such, minimizing the feedback transmission rate implicitly leads to improving the overall network performance.

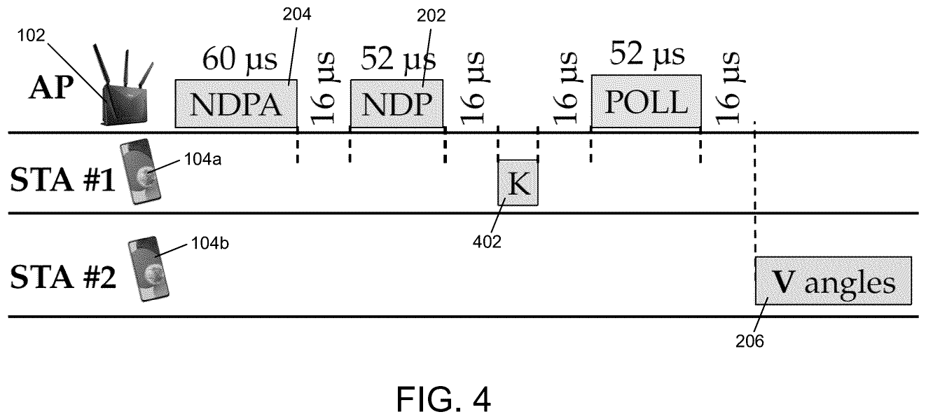

In an example embodiment shown in FIG. 4, each STA decides whether to update the channel information available at the AP for precoding, or let the AP use the previous estimate. The decision is based on a prediction about the throughput variation that would occur if the previous feedback were used. The objective is to provide a mechanism that builds upon the standard 802.11 sounding and allows improving the network performance. To this end, a message exchange procedure is used for sounding where the AP continues to transmit the NDP in broadcast to all the connected STAs. Next, each STA 104a, 104b decides whether to transmit the compressed channel feedback as required by the 802.11 standards, or a NACK packet to inform the AP about the decision of not providing a new estimate. FIG. 4 depicts an example embodiment of SHRINK, where STA1 104a transmits only a NACK 402 while STA2 104b transmits the 802.11 compressed CSI feedback 206.

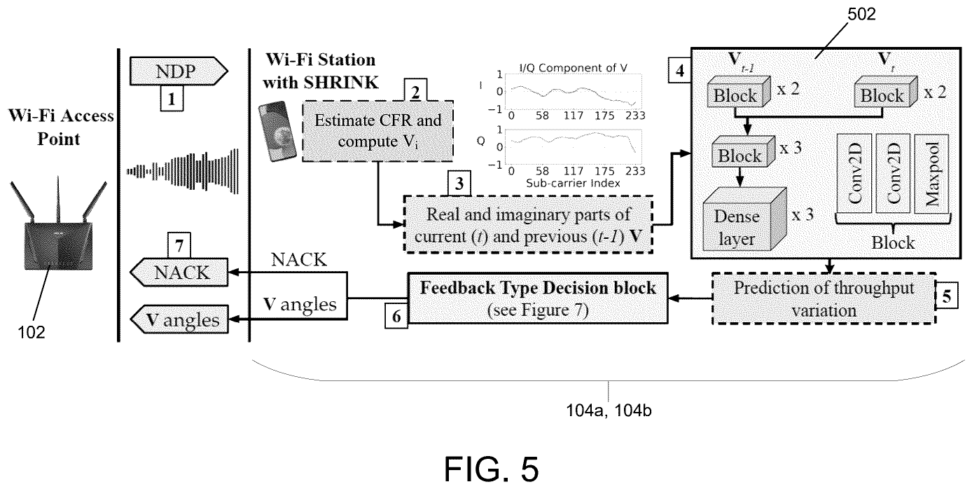

FIG. 5 summarizes the sounding procedure of the described embodiments. The step numbers of the procedure are shown as tags attached to the associated step. The key intuition is to predict the expected throughput variation with a learning-based algorithm. Specifically, upon receiving the NDP (step 1), the STA estimates the CFR and obtains its compressed representation Vᵢ following the standard IEEE 802.11 procedure (step 2). The main idea is to estimate the expected throughput variation rather than relying on the similarities between different CFRs, because even CFR that are very similar in shape (magnitude and phase) across consecutive sounding rounds can lead to significant throughput degradation at the STA if not promptly reported to the AP to update the precoding.

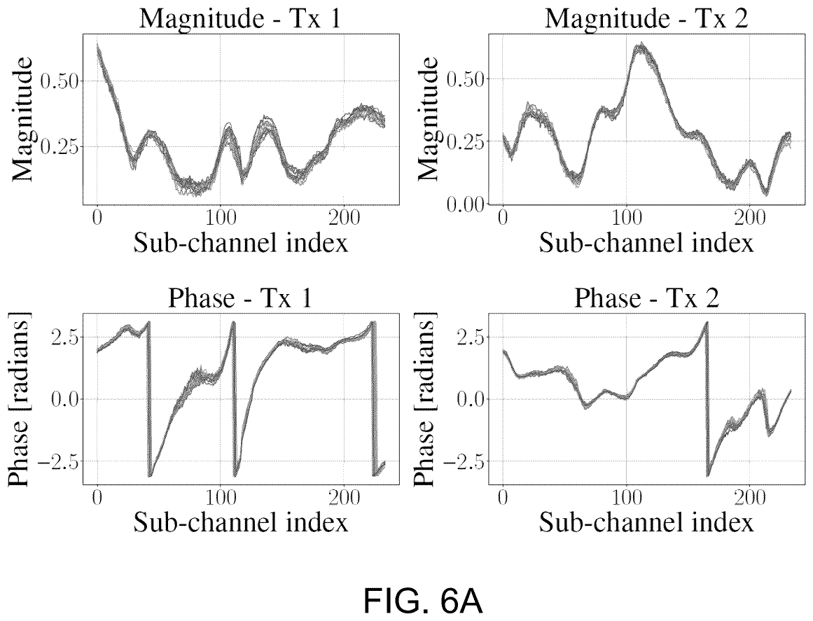

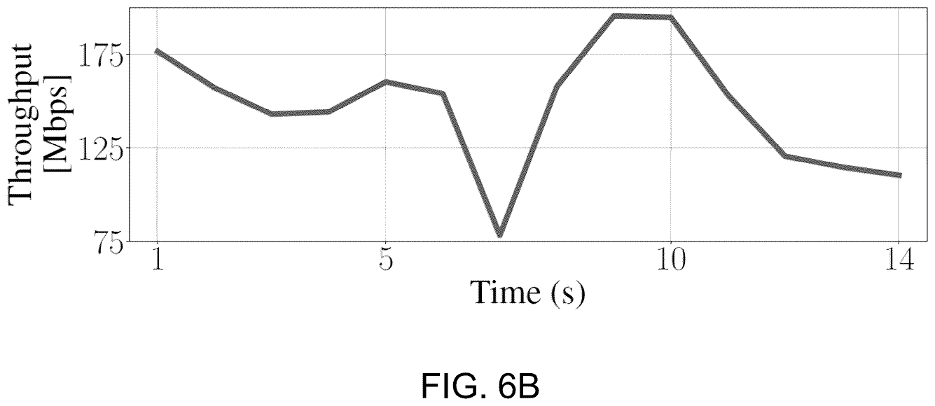

To illustrate this point, FIGS. 6A and 6B show the feedback matrices obtained at a STA together with the throughput variation over 14 different time slots when the AP keeps using the first channel estimate (t=1) for precoding. The results are reported for two different transmitter antennas and show that while the feedback matrices appear similar, the throughput oscillates between 200 Mbps and 75 Mbps. To address this issue, the learning-based block 502 (see FIG. 5), takes as input the real and imaginary parts of the previous and current Vᵢ matrices and predicts the throughput variation that would occur by using the previous channel estimate during the current sounding round (steps 3-4 in FIG. 5). Specifically, the example embodiment uses a Visual Geometry Group (VGG)-based convolutional neural network (CNN) architecture to predict the variation in the throughput at the STA happening in the case the AP precodes with the previous channel estimate instead of using the current one (step 5 in FIG. 5). The description of the CNN-based throughput variation predictor is presented herein. A decision is made as to whether to send the estimate (step 6 in FIG. 5). Based on this, the STA transmits a not-acknowledgement (NACK) 402 or the Vᵢ angles 206 (step 7 in FIG. 5). For simplicity, the STA index i is omitted in the following description.

Learning Architecture. The learning block 502 takes as input the compressed feedback matrix Vₜ estimated by the STA during the current time slot t along with the feedback matrix obtained during the previous sounding round Vₜ₋₁. The feedback matrices are two-dimensional vectors, where the first dimension represents the number of OFDM sub-channels while the second indicates the number of spatial streams. Since these matrices are complex-valued, their real and imaginary parts are extracted and concatenated along the channel dimension. The output of the learning block is the predicted throughput variation at the STA, identified by T_{P,t}=f(θ, Vₜ, Vₜ₋₁), where f represents the function approximated by the learning algorithm and θ is the vector containing its parameters. We use T_{A,t} to indicate the actual throughput variation measured by the STA after data transmission.

The Vₜ and Vₜ₋₁ matrices are first processed in a parallel fashion through two individual CNN branches, each consisting of two convolutional blocks which extract meaningful features for throughput variation prediction. Each convolutional block comprises two convolutional layers followed by a max-pooling layer, where the convolutional layers have an increasing number of filters (64, 64, 128, 256, and 512) with a kernel size of 3×3 and rectified linear units (ReLU). Padding is also applied in convolutional layers to preserve the spatial dimensions, which are only reduced through max-pooling with 2×1 kernels. In total, the number of trainable parameters is 64.63 million. The outputs of these branches are then concatenated along the channel dimension and forwarded through three convolutional blocks. The output of the final convolutional block is then flattened and processed by three fully connected layers with ReLU activation function. Finally, a dense layer with linear activation outputs the predicted throughput variation T_{P,t}.

This learning block 502 is trained by forwarding the pairs of current and previous channel estimates in the training dataset. The predicted throughput variation is compared with the actual variation available in the training dataset for each pair of current and previous channel estimates. We use the mean squared error (MSE) as loss function, i.e.,

$$ℒ ( θ ) = \frac{1}{{N}_{batch}} {\sum }_{b = 0}^{{N}_{batch} - 1} {( {T}_{P , b} - {T}_{A , b} )}^{2} , \qquad ( 1 )$$

where N_{batch} is the batch size. The network weights are updated using a stochastic gradient-based optimization (see, e.g., Diederik P Kingma. Adam: A method for Stochastic Optimization, arXiv preprint arXiv: 1412.6980, 2014).

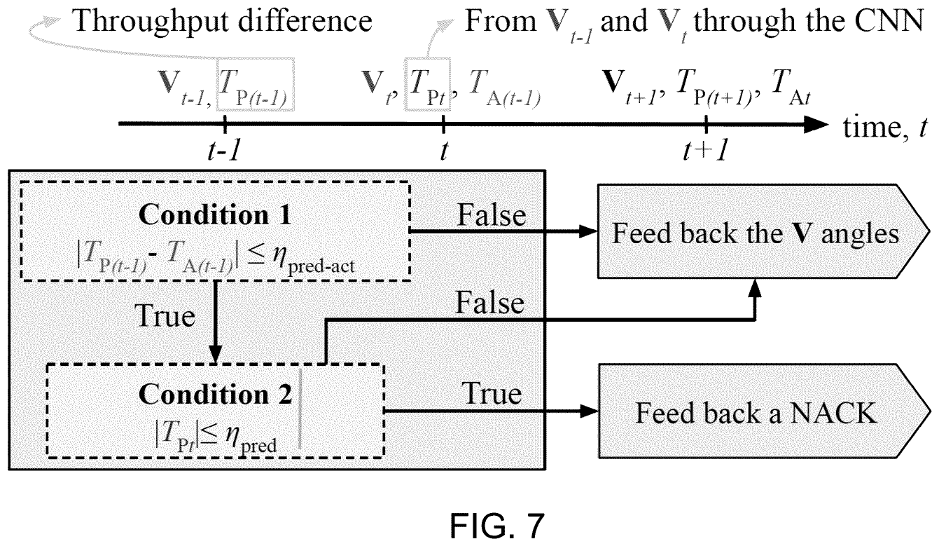

Feedback Type Decision Block. The feedback type decision block processing is summarized in FIG. 7 and detailed in Procedure 1.

Procedure 1: Feedback type decision block

| | Input: Actual throughput variation T_{A(t-1)}; predicted | | |
|---|---|---|---|
| | | | throughput variation T_{P(t-1)}, T_{Pt}; thresholds |
| | | | η_{pred-act}, η_{pred} |
| | Output: Feedback | | |
| 1 | Check Condition 1 | | |
| 2 | if \|T_{P(t-1)} − T_{A(t-1)}\| ≤ η_{pred-act} then | | |
| 3 | \| | Check Condition 2 | |
| 4 | \| | if \|T_{Pt}\| ≤ η_{pred} then | |
| 5 | \| | \| | Feedback ← NACK; |
| 6 | \| | else | |
| 7 | \| | \| | Feedback ← Vₜ angles; |

| 8 | else | |
|---|---|---|
| 9 | \| | Feedback ← Vₜ angles; |

This block decides whether to send back the compressed feedback matrix Vₜ or the NACK. The actual throughput variation is accounted for in the decision as it provides an indication of the predictive model accuracy. Specifically, at each sounding round t, the decision block evaluates the accuracy of the previous throughput variation prediction T_{P(t-1)} by comparing it with the actual variation T_{A(t-1)}. A user-defined threshold η_{pred-act} decides whether the difference is acceptable for the specific application (Condition 1 in lines 1-2 in Procedure 1).

Condition 1 is false. If the difference between the predicted and actual throughput variation is higher than η_{pred-act}, the STA feeds back the Vₜ angles (line 9 in Procedure 1). This indicates that the predictor was not accurate during the last sounding round. Hence, the AP is provided with the most updated channel estimate.

Condition 1 is true. If the previous throughput variation prediction is good enough, i.e., Condition 1 in line 2 of Procedure 1 is verified, the STA checks the current throughput variation prediction T_{Pt}. If the predicted throughput variation is smaller than or equal to threshold 1) pred (Condition 2 in line 3-4 in Procedure 1), the STA assumes that the channel is almost static and the previous channel estimate can be used for precoding. The STA informs the AP about this by feeding back a NACK frame (line 5 in Procedure 1). Otherwise, the new channel estimate is fed back to the AP (line 7).

As described herein, throughput prediction accuracy decreases over time, requiring periodic fine-tuning of predictor parameters. As such, the example embodiment uses a continual learning (CL) strategy, which is executed when the prediction performance drops below a predefined threshold, as detailed in Procedure 2.

| | | Procedure 2: Complete SHRINK sounding procedure |
|---|---|---|
| | Input: T_{A(t-1)}, T_{P(t-1)}, η_{pred-act}, η_{pred}, N_{S} | |
| 1 | while STATIC = = True do | |
| 2 | \| | Estimate T_{Pt} using SHRINK CNN in Section 3.2; |
| 3 | \| | Execute Algorithm 1 (see Section 3.3); |
| 4 | \| | ${ε}_{cum} ← {\sum }_{τ = t - {N}_{S}}^{t - 1} {( {T}_{P τ} - {T}_{A τ} )}^{2} ;$ |
| 5 | \| | if ε_{cum}/N_{S} > η_{pred-act} then |
| 6 | \| | \| STATIC ← False; |
| 7 | \| | \| Go to line 8; |
| 8 | while STATIC = = False do | |
| 9 | \| | Compute correlation among the last N_{S} estimated V |
| | | matrices; |
| 10 | \| | if correlation > 0.9 // channel static but |
| | | inaccurate estimates |
| 11 | \| | then |
| 12 | \| | \| STATIC ← True; |
| 13 | \| | \| Apply CL to update the CNN parameters θ using the |
| | | \| last N_{S} estimated Vₜ matrices (see Section 3.5); |
| 14 | \| | \| t ← t + 1; // next sounding round |
| 15 | \| | \| Go to line 1; |
| 16 | \| | else |
| | | \| // channel not static |
| 17 | \| | \| for i ← 1 to N_{S} do |
| 18 | \| | \| \| t ← t + 1; // next sounding round |
| 19 | \| | \| \| Feedback + Vₜ angles; |
| 20 | \| | \| \| ε_{com} ← ε_{cum} + (T_{P(t-1)} − T_{A(t-1)})²; |
| 21 | \| | \| \| Estimate T_{Pt} using SHRINK CNN in Section 3,2; |
| 22 | \| | \| if ε_{com}/N_{S} < η_{pred-act} then |
| 23 | \| | \| \| STATIC ← True; |
| 24 | \| | \| \| t ← t + 1; // next sounding round |
| 23 | \| | \| \| Go to line 1 // the channel stabilized and |
| | \| | \| \| the previous training is still good |
| 26 | \| | \| else |
| 27 | \| | \| \| ε_{cum} ← 0; |
| 28 | \| | \| \| Go to line 17 // channel not static |

After estimating the throughput variation T_{Pt} using the CNN-based prediction block (line 2, Procedure 2) and executing the feedback type decision block (line 3, Procedure 2), the cumulative error over the most recent N_{S} samples ε_{cum} (line 4, Procedure 2) determines whether the CNN parameters should be updated through CL. Specifically, when the average cumulative error ε_{cum}/N_{S} exceeds the threshold pred-act, the STA assumes that the CNN prediction module is not working properly. This can happen due to one of the following two reasons: (i) the environment became highly dynamic, or (ii) the environment is still almost static but the propagation statistics changed and, in turn, the CNN-based model is no longer able to predict well the throughput variation. In the first case, the STA should keep transmitting the V angles instead of the NACK until the wireless channel stabilizes again. In the second case, the STA should use the last N_{S} estimated Vₜ matrices, representing the new channel conditions, to update the CNN model's parameters through CL. Note that in the first case, refining the model would be ineffective as the wireless propagation environment is not static and, the transmission of the most updated channel estimates cannot be avoided. To determine whether the situation is (i) or (ii), the STA analyzes the correlation among the N_{S} most recent channel estimates (line 9 in Procedure 2). If the correlation index exceeds 0.9, the STA assumes the channel is almost static, but the previously trained model is no longer able to predict the throughput variation with adequate accuracy (lines 10-12, Procedure 2). Hence, it uses the last N_{S} estimated Vₜ matrices to update the CNN model's parameters using the CL strategy detailed in line 13 of Procedure 3. Afterwards, the STA goes back to executing the SHRINK sounding procedure, i.e., Procedure 2 execution iterates using the updated CNN (lines 14-15, Procedure 2). If the correlation among the collected N_{S} Vₜ matrices is below 0.9, the channel is considered dynamic (line 16, Procedure 2). Hence, the STA executes the standard 802.11 procedure, i.e., it feeds back the Vₜ angles (line 19, Procedure 2), keeping track of the cumulative error (εcum) in estimating the throughput (lines 20-21). After N_{S} sounding rounds (lines 17-18, Procedure 2), the STA checks if the average cumulative error εcum/N_{S} is below the threshold ηpred-act (line 22, Procedure 2), which means that the channel stabilized and the previously trained CNN model remains valid (line 23, Procedure 2). In this case, the STA resumes to use the SHRINK approach by iterating Procedure 2 using the previously trained CNN (lines 24-25). Otherwise, the STA resets the ∈_{cum} counter (line 27) and continues feeding back Vₜ angles (line 28), waiting for the channel to stabilize.

Continual Learning Mechanism. The elastic weight consolidation (EWC) technique is employed as the CL strategy to refine the model in real time. Refinement is triggered by Procedure 2 when the channel is nearly static, but the CNN model fails to predict its behavior (line 11, Procedure 2). The EWC procedure is summarized in Procedure 3.

Procedure 3: EWC continual learning procedure

| | Input: Model parameters θ, datasets Dₜᵣₐᵢₙ, D_{refine} | |
|---|---|---|
| | Output: Updated model parameters \tilde{θ} | |
| 1 | Step 1: Compute Fisher information matrix on the | |
| | original dataset | |
| 2 | \| | Use Equation 2 to compute the FIM for each CNN |
| | \| | parameter θₗ considering the model's gradients of the |
| | \| | loss with respect to the samples in Dₜᵣₐᵢₙ; |
| 3 | Step 2: Train the CNN with the new dataset | |
| 4 | \| | Initialize the refined CNN: \tilde{θ} ← θ; |
| 5 | \| | Train the CNN \tilde{θ} using dataset D_{refine} and the loss |
| | \| | function in Equation 3. |

To avoid incurring catastrophic forgetting, a key challenge in CL, we first estimate the importance of each parameter of the CNN-based architecture in performing the prediction of the throughput variation. Specifically, we use the Fisher information matrix (FIM) F as a measure for this. Indicating with n∈{1, . . . , N} the elements in the Dₜᵣₐᵢₙ dataset originally used to train the model, the l-th element of the FIM, i.e., the one associated with the e-th parameter of the CNN architecture θₗ, is obtained as (Step 1 in Procedure 3)

$${F}_{ℓ} = \frac{1}{N} {\sum }_{n = 1}^{N} {( \frac{\partial {ℒ}_{n}}{\partial {θ}_{ℓ}} )}^{2} , \qquad ( 2 )$$

where [symbol] is the loss obtained for the n-th data sample using Procedure 1, and ϑ [symbol] /ϑθₗ is the gradient of the loss with respect to the parameter θₗ. At this point, the CNN-based architecture is trained using the new dataset D_{refine} (Step 2 in Procedure 3). The updated CNN parameter vector, indicated by \tilde{θ}, is initialized with the parameters of the originally trained model θ. Hence, the parameters are updated by backpropagating the gradient of the loss function defined as

$$\tilde{ℒ} ( θ , \tilde{θ} ) = ℒ ( θ ) + λ \cdot {ℒ}_{EWC} ( θ , \tilde{θ} ) , \qquad ( 3 )$$

where [symbol] _{EWC}(θ)=Fᵢ(\tilde{θ}−θ)² and λ is the regularization parameter that controls the importance of the EWC penalty during the retraining phase. The SHRINK CNN-based model requires on average 95 seconds for training and 15 seconds for CL retraining. During the retraining phase, the system follows the standard 802.11 channel sounding procedure to maintain the MIMO communication active.

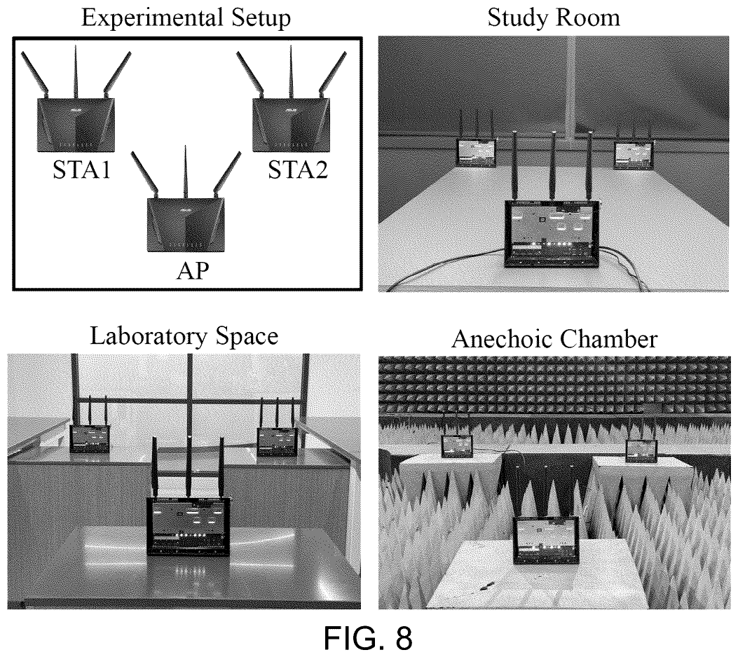

Experimental Setup. We evaluated the performance of the SHRINK example embodiment using a MU-MIMO testbed consisting of one AP and two STAs, deployed in (i) a study room, (ii) a laboratory space, and (iii) an anechoic chamber, as depicted in FIG. 8. Commercial off-the-shelf Asus RT-AC86U IEEE 802.11ac Wi-Fi routers were employed as both AP and STAs. Four antennas were enabled at the AP while the STAs have one antenna each. Working with commercial devices allows an effective demonstration of the impact of the SHRINK sounding method. However, this is challenging as vendors do not provide access to inner operations such as channel estimation. Hence, to implement SHRINK, we had to reverse-engineer the channel sounding procedure on the Asus RT-AC86U devices and modify its functionality. The Wi-Fi chipset in such devices is the Broadcom BCM4365, featuring a D11 microcontroller that can be modified using the Nexmon framework. The necessary firmware modifications were implemented at the STA using Nexmon, while the AP was kept unmodified. The modifications were implemented in one or both STAs, depending on the specific evaluation. This way, one STA can be used as the standard benchmark for performance comparison. Indeed, being served in MU-MIMO mode, the two STAs normally experience the same average throughput. We used the Wi-BFI tool to reconstruct the V matrices from the V angles extracted from the Broadcom chipset at the modified STAs. The V matrices serve as input for our feedback type decision block to decide the type of feedback to be used.

Network Setup. The Wi-Fi network managed by the AP was operating following IEEE 802.11ac standards on channel 157 with 80 MHz bandwidth. The sub-channel grouping factor N_{g} was 1, while the number of bits for quantization was set to b_{φ}=9 bits and b_{ψ}=7 bits for φ and ψ, respectively. These parameters were automatically set by the unmodified AP and are not controllable. iperf sessions between the AP and each of the connected STAs (modified and unmodified) were established to evaluate the SHRINK effectiveness. User Datagram Protocol (UDP) packets (1500 bytes-long) were transmitted to saturate channel capacity. We collected V matrices thanks to Nexmon-based firmware modifications and throughput directly from the iperf sessions. Considering the selected operational parameters, the size of the feedback matrix V is 234×4×1, where 234 identifies the number of OFDM data sub-carriers, and 4 and 1 are the numbers of transmit antennas at the AP and receiver antennas at the STA, respectively. As we only have control over the STAs, we emulated the behavior of the AP at the reception of NACK as the feedback by feeding it back the previous channel estimate when no update is required. In turn, the unmodified AP uses such a previous channel estimate for precoding. We chose this approach to avoid modifying the AP and letting it operate following the standard 802.11 procedures.

Learning Setup. To train the CNN-based throughput variation predictor we collected real channel data for 2,500 sounding rounds on each of the different environments in almost static conditions (i.e., no people were performing highly dynamic activities in the environment), and in dynamic conditions (i.e., people moving in the scene). Note that while the measurements collected in the anechoic chamber do not include external interference sources, the laboratory space and the study room are uncontrolled wireless environments, i.e., other Wi-Fi APs and STAs were operating simultaneously with our system during data collection.

Performance Evaluation. This section first evaluates the performance of the CNN model in predicting the throughput variation for different environments, together with the effectiveness of the CL method using different numbers of samples. Hence, SHRINK is compared with the existing IEEE 802.11 sounding and other state-of-the-art approaches. In our evaluations, we set η_{pred-act} and pred in Procedures 1 and 2 to 20 Mbps.

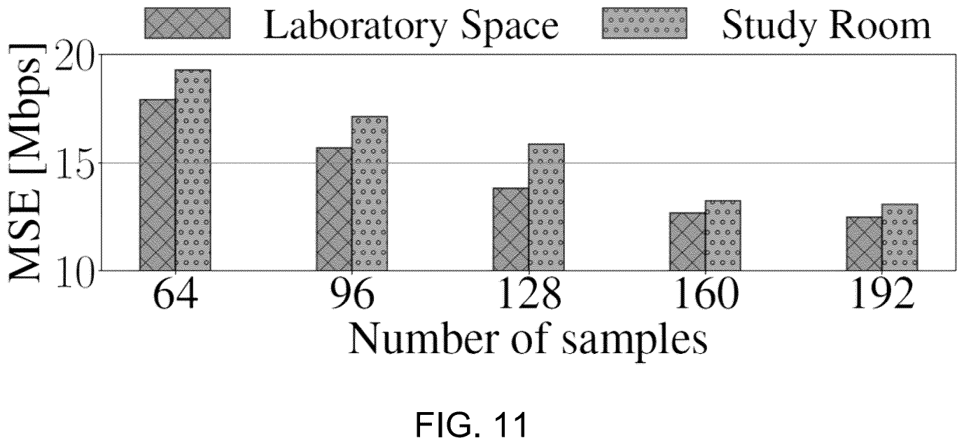

Selection of the N_{S} hyperparameter. FIG. 11 shows the performance of the proposed CL approach when changing the number of samples used to retrain the network at runtime. The laboratory space and the study room were considered as experimental locations. The test sample sizes for the retraining phase range from 64 to 192. FIG. 11 illustrates that the mean squared error (MSE) in predicting throughput variation decreases with more samples. Based on these results, we set N_{S}, i.e., the number of samples to be used for SHRINK CL, to 160, balancing retraining performance and time. Indeed, increasing the number of samples from 160 to 192 yields negligible MSE reduction (0.19 Mbps and 0.17 Mbps in the laboratory space and study room, respectively) while extending sample acquisition and retraining time. Instead, the retraining phase should remain short to reduce the overhead of continuously transmitting V angles, which introduces an airtime overhead for control data.

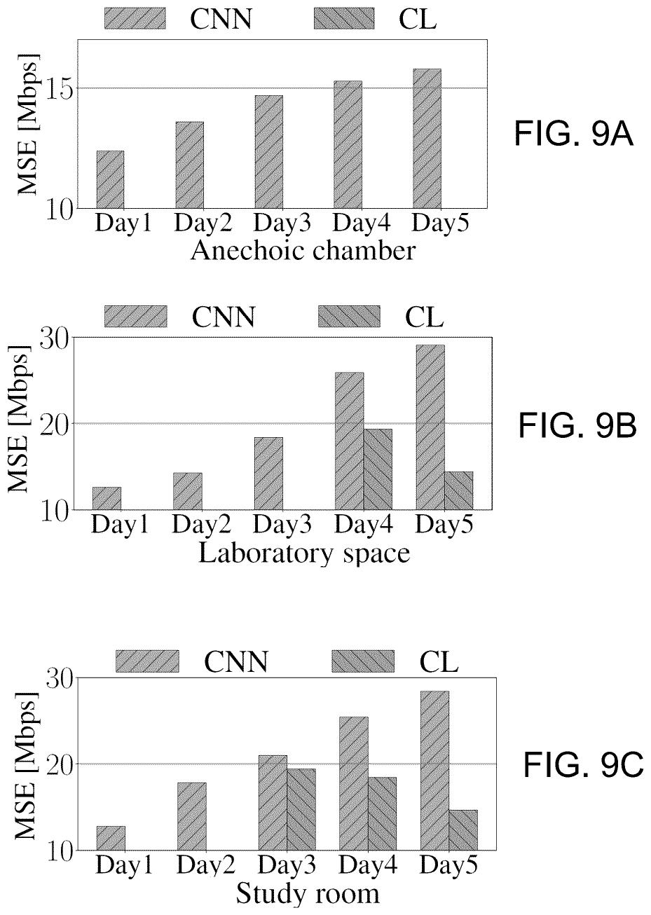

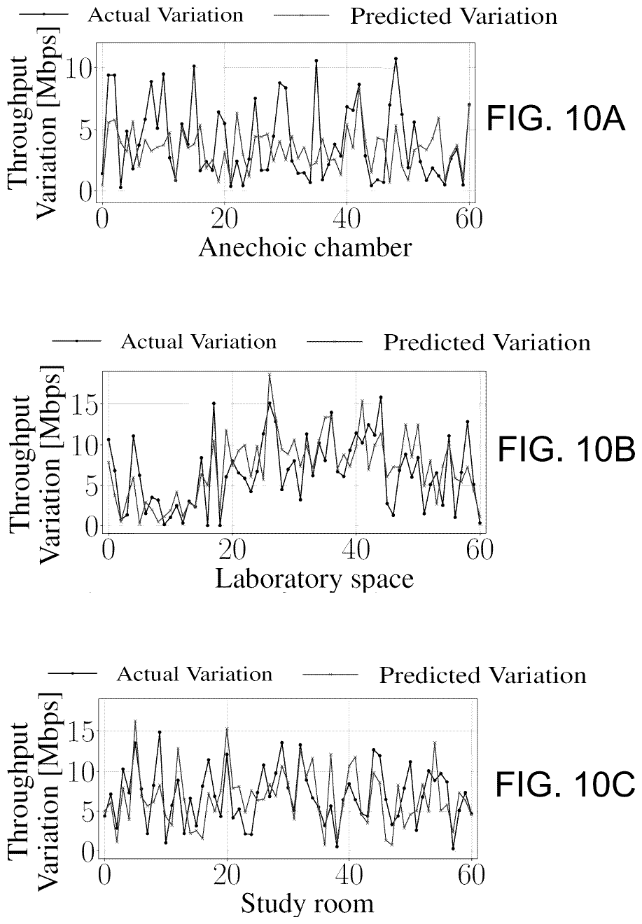

Throughput Predictor Performance. Data was collected from the three different environments and trained a separate CNN model for each environment. The generalization performance of the trained CNN model was evaluated on five different days. While no macro-movements are being performed, small variations in the propagation environment always happen, also linked with temperature and humidity variations, causing slight degradation in the performance of the CNN-based throughput variation predictor over time, as depicted in FIGS. 9A, 9B, and 9C. The performance decrease is more significant in the laboratory space and in the study room, where the MSE increases by more than 15 Mbps over five different days. To counteract this, the SHRINK CL mechanism described in Procedure 3 is executed to restore adequate throughput variation prediction performance. The second set of bars in FIGS. 9A, 9B, and 9C illustrates the MSE decrease obtained after applying CL. The results show that when the MSE exceeds the 20 Mbps threshold, the CL block retrains the CNN to adapt it to the new conditions. Notably, in the anechoic chamber, the MSE remains consistently below the defined threshold over five different days (see FIG. 9A). In turn, SHRINK does not start a CL phase to retrain the model for this environment. Instead, in the laboratory environment (see FIG. 9B), the MSE stays within the threshold until the third day but reaches 25.93 Mbps and 29.10 Mbps on the fourth and fifth day. Hence, SHRINK triggers the CL phase. This decreases the MSE to 19.38 Mbps and 14.40 Mbps, respectively. Similarly, in the study room (see FIG. 9C), the MSE exceeds the threshold starting from the third day, (the MSE is 21.02 Mbps, 25.44 Mbps, and 28.38 Mbps respectively for the third, fourth and fifth day). Through retraining, the MSE is kept below the threshold (the values are 19.42 Mbps, 18.44 Mbps, and 14.68 Mbps, respectively). FIGS. 10A, 10B, and 10C provide some visual examples of actual versus SHRINK CNN-based predicted throughput variations in all environments. The results show that the throughput variation predicted by SHRINK effectively follows the same trend as the actual variation, confirming the results in FIGS. 9A, 9B, and 9C.

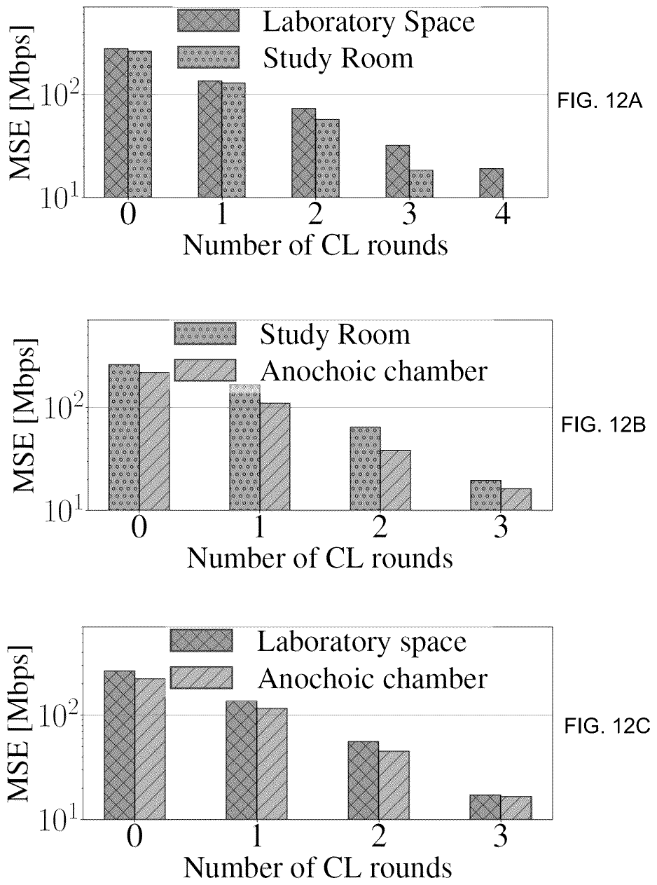

Predictor Generalization Performance. The generalization performance of the CNN-based throughput variation predictor was assessed by training it in one environment and testing it in the others. FIGS. 12A, 12B, and 12C present the results for different combinations of training-testing environments. The leftmost groups of bars labeled as ‘0’ in the x-axis, represent the MSE when using the pre-trained model in the new environments without applying retraining through CL, while the subsequent bars show the MSE reduction after an increasing number of rounds of CL refinements (see Section 3.5). Each CL round considers N_{S}=160 new data samples, i.e., 1.6 seconds of new channel estimate recordings. The CL refinement stops as soon as the MSE threshold η_{pred-act}=20 Mbps is met. The results show that less than five CL rounds are needed to adapt the model to new environments, and three rounds are sufficient in most cases. For example, FIG. 12A shows that the MSE of a model pre-trained in the anechoic chamber reaches 19.18 Mbps and 18.37 Mbps after four and three rounds in the laboratory space and the study room, respectively. Similarly, when trained in the laboratory space, the predictor requires three CL rounds to adapt to the study room and the anechoic chamber, reaching an MSE of 19.57 Mbps and 16.23 Mbps respectively (see FIG. 12B). Three CL rounds are enough also when pre-training the predictor in the study room: the MSE reaches 17.25 Mbps in the laboratory space and 16.73 Mbps in the anechoic chamber (see FIG. 12C). Overall, the results show that SHRINK can quickly adapt to new environments with less than 5 seconds of new data samples. This is key for the effective deployment of sounding rate adaptation strategies in commercial Wi-Fi devices.

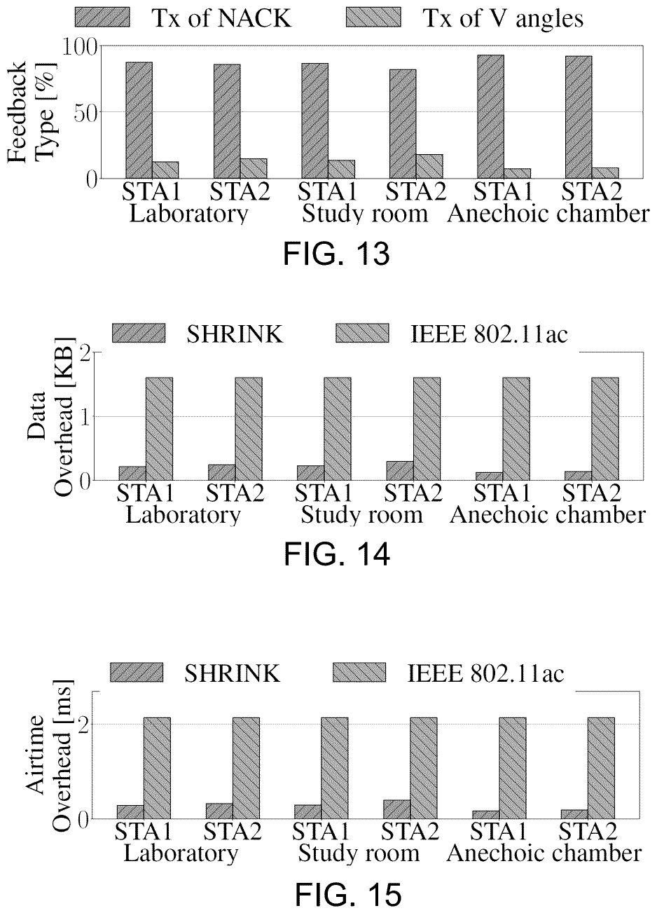

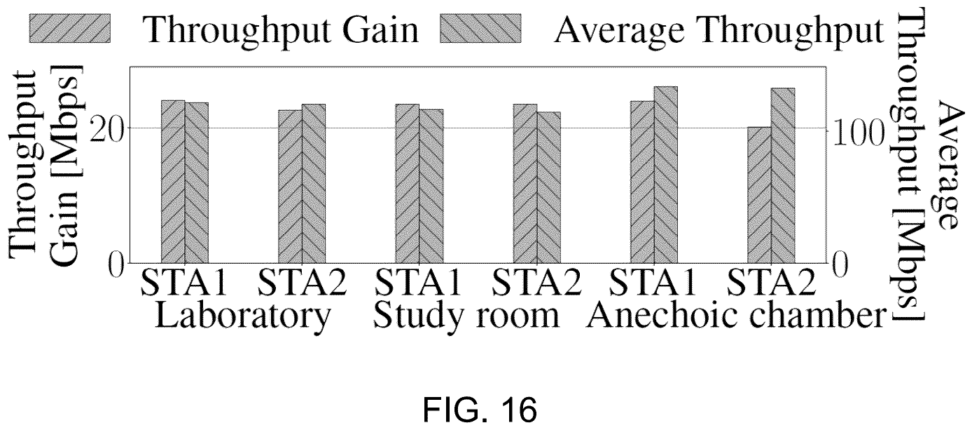

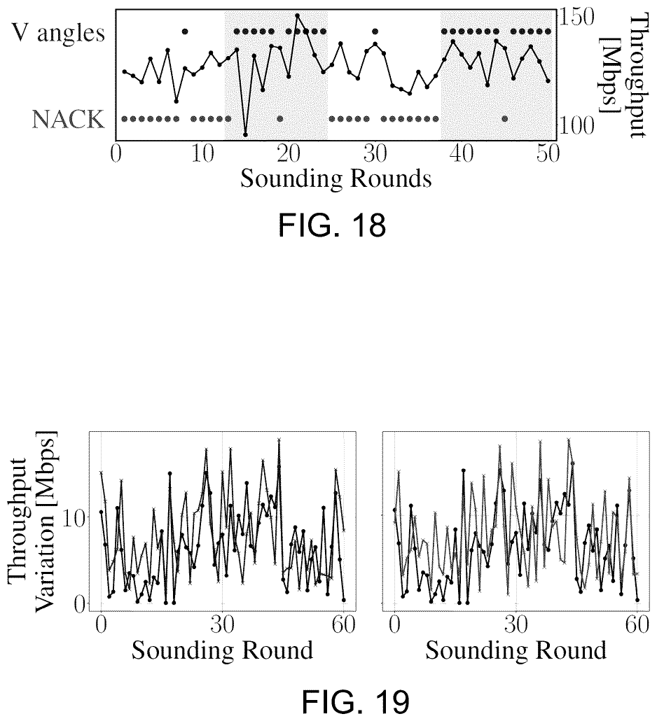

SHRINK Channel Sounding Performance. We evaluated the performance of SHRINK channel sounding in terms of feedback type, data and airtime overhead, and compared it with the existing IEEE 802.11ac procedure. The metrics were obtained by averaging the results over 160 sounding rounds. FIG. 13 shows the feedback type selected by the two STAs in the network when they both use the SHRINK mechanism. In the laboratory space, STA1 and STA2 transmit NACK, thus avoiding V angle transmission, for respectively 87.5% and 85.6% of the total sounding rounds. This reduces the airtime overhead associated with control data transmission, unlocking spectrum resources that can be used for data transmissions. FIGS. 14 and 15 compare SHRINK and 802.11 channel sounding in terms of data and airtime overhead. The average data overhead per sounding round decreases from 1.602 KB (IEEE 802.11ac) to 0.227 KB (SHRINK). Regarding the airtime overhead, while the 802.11 sounding procedure occupies the channel for 2.135 ms, SHRINK requires only 0.303 ms on average. In turn, as shown in FIG. 16, SHRINK increases throughput by more than 22 Mbps compared to the IEEE 802.11 approach, with STA1 and STA2 achieving average throughput of more than 120 Mbps. A similar analysis was carried out in the study room, and the anechoic chamber (see FIGS. 13, 14, 15, and 16). In the study room, the STAs transmit NACK for more than 80% of sounding rounds (see FIG. 13), reducing data and airtime overhead by more than 1.34 KB and 1.79 ms on average (see FIGS. 14, 15), with throughput increases by more than 23 Mbps and average throughput of more than 114 Mbps (see FIG. 16). With the more stable wireless channel in the anechoic chamber, the two STAs select NACK feedback for 92.9% and 92.2% of the total sounding rounds (see FIG. 13), reducing data and airtime overhead by an average of 1.47 KB and 1.96 ms (FIG. 14 and FIG. 15). Finally, throughput increases by more than 20 Mbps at both STAs with average values reaching more than 132 Mbps (see FIG. 16). SHRINK was further evaluated in a laboratory space, with and without human movement to assess the effectiveness of the feedback type decision block in Section 3.3. Results in FIG. 18 show that in stable channels (no movement), SHRINK transmits NACK, reducing control data overhead. In contrast, the presence of human movement triggers more frequent transmissions of the V angles as the channel changes faster. The black line indicates the actual throughput measured by the STA and shows that although the feedback type changes, the performance does not degrade considerably.

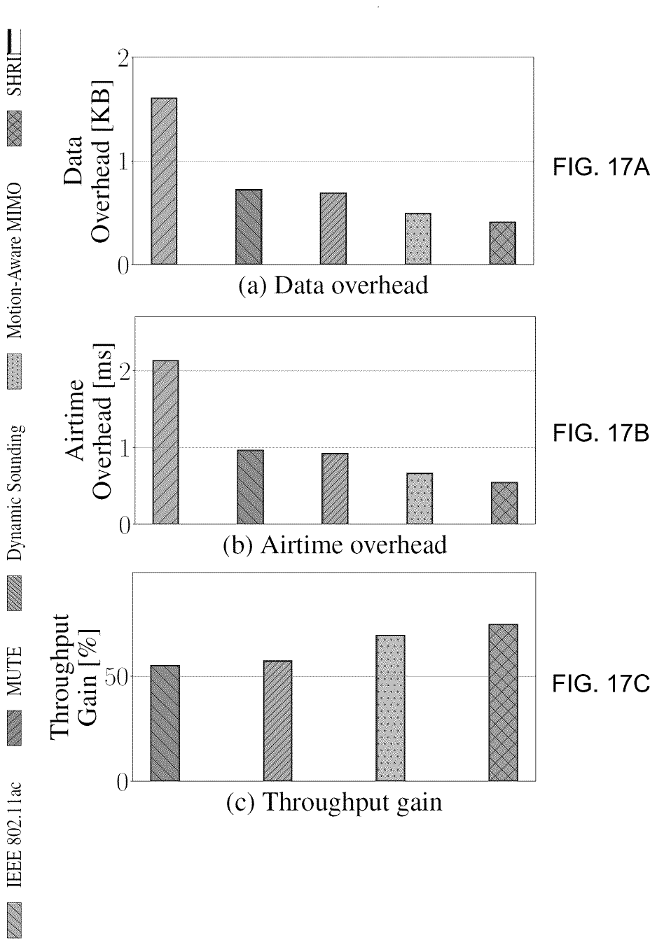

Comparison with Existing Baselines. SHRINK is compared with three state-of-the-art approaches for sounding rate reduction: MUTE, Dynamic Sounding, and Motion-aware MIMO. FIGS. 17A, 17B, and 17C show that SHRINK outperforms these approaches in terms of data and airtime overhead, and overall throughput gain at the STA. Specifically, SHRINK reduces data and airtime overhead by 0.09 KB and 0.11 ms on average compared to Motion-aware MIMO, and by 0.31 KB, 0.28 KB, 0.4 ms, and 0.37 ms on average compared to MUTE and Dynamic Sounding. Finally, the throughput gain with respect to the IEEE 802.11 approach is 55%, 57%, and 69% for MUTE, Dynamic Sounding, and Motion-aware MIMO, respectively, while SHRINK achieves 74.4% (see FIG. 17C). Overall, results show that performing sounding rate management at STAs, as in SHRINK, adapts more effectively to channel variations than AP-based schemes. As discussed herein, in fact, SHRINK leverages recent channel estimates and throughput to select the appropriate feedback. Instead, MUTE, Dynamic Sounding, and Motion-aware MIMO rely on AP-based estimations, which are prone to estimation errors. In turn, using these estimates instead of actual values represents a sub-optimal approach for sounding rate adaptation.

Comparison with Existing Estimators. As a final evaluation, we also compared the performance of our throughput variation predictor with the throughput estimator used in Dynamic sounding and in Motion-aware MIMO sounding rate adaptation approaches. FIG. 19 shows an example of the throughput variation estimated by Dynamic Sounding and Motion-aware MIMO in the laboratory space, while the prediction obtained through SHRINK is depicted in FIG. 10B. Overall, the MSE in the throughput estimation (averaged over 480 samples) is 16.63 Mbps by Dynamic sounding and is 13.81 Mbps by Motion-aware MIMO, while it decreases to 13.08 Mbps when using our proposed approach. FIG. 19 shows actual throughput variation (black line) and variation estimated by Dynamic sounding (blue line, left plot) and Motion-aware MIMO (red line, right plot) in the laboratory space. These results indicate that SHRINK's predictor outperforms the other approaches, further proving the effectiveness of performing the throughput prediction at the STAs where the actual channel and throughput measurements are available, rather than relying on the throughput estimated at the AP based on transmission metrics for the decision.

While example embodiments have been particularly shown and described, it will be understood by those skilled in the art that various changes in form and details may be made therein without departing from the scope of the embodiments encompassed by the appended claims.

What is claimed is:

1. A method of channel-sounding in a wireless communication system, comprising:
transmitting, by an access point transceiver, a solicitation for channel frequency response (CFR) feedback;
determining, by a station transceiver, a current channel frequency response for each multiple-input multiple-output (MIMO) channel between the access point transceiver and the station transceiver;
determining, by the station transceiver using a throughput variation predictor, a predicted prior throughput variation resulting from precoding use of a prior channel frequency response produced from a channel sounding interval immediately preceding a current channel sounding interval;
transmitting, by the station transceiver, the current channel frequency response when the throughput variation exceeds a throughput variation threshold; and
transmitting, by the station transceiver, a not-acknowledge (NACK) message when the throughput variation does not exceed the throughput variation threshold.

2. The method of claim 1, wherein the wireless communication system is an IEEE 802.11 communication system.

3. The method of claim 1, wherein predicting the prior throughput variation further comprises determining accuracy of a throughput variation predictor, and transmitting, by the station receiver, the current channel frequency response when the accuracy of the throughput variation predictor does not meet an accuracy requirement.

4. The method of claim 3, wherein determining accuracy of the throughput variation predictor further comprises (i) determining an actual prior throughput variation that occurred for the channel sounding interval immediately preceding the current channel sounding interval, (ii) determining that the accuracy of the throughput variation predictor meets the accuracy requirement when a magnitude of a difference between the actual prior throughput variation and the predicted prior throughput variation is less than or equal to an accuracy threshold, and (iii) determining that the accuracy of the throughput variation predictor does not meet the accuracy requirement when the magnitude of the difference between the actual prior throughput variation and the predicted prior throughput variation is greater than the accuracy threshold.

5. The method of claim 1, wherein predicting the throughput variation further comprises
(i) determining, from the current channel frequency response, a current beamforming matrix Vᵢ₍ₜ₎;
(ii) determining, from the prior channel frequency response, a prior beamforming matrix Vᵢ₍ₜ₋₁₎; and
(iii) predicting, by a learning-based model, the throughput variation based on Vᵢ₍ₜ₎ and Vᵢ₍ₜ₋₁₎ as inputs to the learning-based model.

6. The method of claim 5, wherein the learning-based model uses a Visual Geometry Group (VGG)-based convolutional neural network (CNN) architecture.

7. The method of claim 5, further comprising training the learning-based model by (a) providing a training database of current training channel frequency response and prior training channel frequency response pairs, and (b) forwarding the current channel frequency response and prior channel frequency response pairs to the learning-based model.

8. The method of claim 7, further comprising using a mean squared error loss function to quantify an error between the current training channel frequency response and prior training channel frequency response pairs and using a gradient-based optimization to adjust parameters of the learning-based model.

9. The method of claim 7, further comprising employing an elastic weight consolidation technique to refine the learning-based model, wherein parameters of the learning-based model are updated by backpropagating a gradient of a Fisher information matrix-based loss function.

10. A wireless communication system for channel-sounding, comprising:
an access point transceiver that transmits a solicitation for channel frequency response (CFR) feedback;
a station transceiver that, in response to the solicitation,
(i) determines a current channel frequency response for each multiple-input multiple-output (MIMO) channel between the access point transceiver and the station transceiver,
(ii) determines, using a throughput variation predictor, a predicted prior throughput variation resulting from precoding use of a prior channel frequency response produced from a channel sounding interval immediately preceding a current channel sounding interval;
(iii) transmits the current channel frequency response when the throughput variation exceeds a threshold; and
(iv) transmits a not-acknowledge (NACK) message when the throughput variation does not exceed the threshold.

11. The system of claim 10, wherein the wireless communication system is an IEEE 802.11 communication system.

12. The system of claim 10, wherein the station transceiver further determines accuracy of a throughput variation predictor, and transmits the current channel frequency response when the accuracy of the throughput variation predictor does not meet an accuracy requirement.

13. The system of claim 12, wherein to determine accuracy of the throughput variation predictor, the station transceiver further (i) determines an actual prior throughput variation that occurred for the channel sounding interval immediately preceding the current channel sounding interval, (ii) determines that the accuracy of the throughput variation predictor meets the accuracy requirement when a magnitude of a difference between the actual prior throughput variation and the predicted prior throughput variation is less than or equal to an accuracy threshold, and (iii) determines that the accuracy of the throughput variation predictor does not meet the accuracy requirement when the magnitude of the difference between the actual prior throughput variation and the predicted prior throughput variation is greater than the accuracy threshold.

14. The system of claim 10, wherein to predict the throughput variation, the station transceiver further
(i) determines, from the current channel frequency response, a current beamforming matrix Vᵢ₍ₜ₎;
(ii) determines, from the prior channel frequency response, a prior beamforming matrix Vᵢ₍ₜ₋₁₎; and
(iii) predicts, by a learning-based model, the throughput variation based on Vᵢ₍ₜ₎ and Vᵢ₍ₜ₋₁₎ as inputs to the learning-based model.

15. The system of claim 14, wherein the learning-based model uses a Visual Geometry Group (VGG)-based convolutional neural network (CNN) architecture.

16. The system of claim 14, wherein to train the learning-based model, the station transceiver further (a) provides a training database of current training channel frequency response and prior training channel frequency response pairs, and (b) forwards the current channel frequency response and prior channel frequency response pairs to the learning-based model.

17. The system of claim 16, wherein the station transceiver uses a mean squared error loss function to quantify an error between the current training channel frequency response and prior training channel frequency response pairs and uses a gradient-based optimization to adjust parameters of the learning-based model.

18. The system of claim 16, wherein the station transceiver further employs an elastic weight consolidation technique to refine the learning-based model, and wherein parameters of the learning-based model are updated by backpropagation of a gradient of a Fisher information matrix-based loss function.

19. A method of channel-sounding, comprising:
determining, by a station transceiver in response to a solicitation for channel frequency response (CFR) feedback, a current channel frequency response for channels between a source of the solicitation and the station transceiver;
determining, by the station transceiver, a predicted prior throughput variation resulting from precoding use of a prior channel frequency response produced from a channel sounding interval immediately preceding a current channel sounding interval;
transmitting, by the station transceiver, the current channel frequency response when the throughput variation exceeds a throughput variation threshold; and
transmitting, by the station transceiver, a not-acknowledge (NACK) message when the throughput variation does not exceed the throughput variation threshold.

20. The method of claim 19, wherein predicting the prior throughput variation further comprises determining accuracy of a throughput variation predictor, and transmitting, by the station receiver, the current channel frequency response when the accuracy of the throughput variation predictor does not meet an accuracy requirement.
